(19) United States
(12) Patent Application Publication
(10) Pub. No.: US 2004/0012615 A1
(43) Pub. Date: Jan. 22, 2004

(54) Mobile communication terminal capable of editing a screen image on a display and method thereof

(75) Inventor: Woo-Suk Jang, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/403,574

(22) Filed: Mar. 31, 2003

(30) Foreign Application Priority Data
Jul. 19, 2002 (KR) 2002-42557

(51) Int. Cl. G09G 5/00

(52) U.S. Cl. 345/661

(57) ABSTRACT

An apparatus and method in which a user directly designs a screen image. A picture sub-image, the user's name sub-image, and a clock sub-image can be implemented in one or more basic frames, enabling the user to edit the screen image displayed on a display module provided in the mobile communication terminal. The basic frames are configured so that it is possible for a size or position of the picture, clock or user's name sub-image to be changed or adjusted on the display module. Through the basic frames, the user can customize the screen image displayed on the display module provided in the mobile communication terminal on the basis of the user's taste. The screen image having the basic frames can be completely implemented within the mobile communication terminal. Alternatively, the user configures the screen image having the basic frames on a personal computer and then downloads the configured screen image from the personal computer to the mobile communication terminal.

### PRIORITY

This application claims priority to an application entitled “APPARATUS AND METHOD FOR EDITING SCREEN IMAGE IN MOBILE COMMUNICATION TERMINAL”, filed in the Korean Industrial Property Office on Jul. 19, 2002 and assigned Ser. No. 2002-42557, the contents of which are hereby incorporated by reference.

### BACKGROUND OF THE INVENTION

1. Field of the Invention

The present invention relates to an apparatus and method for editing a background screen image in a mobile communication terminal.

2. Description of the Related Art

Generally, a screen image is uniformly configured on a display screen provided in a mobile communication terminal. For example, a user of the mobile communication terminal can select an image such as a picture, a user's name, or a clock, and then display the selected image on a predetermined screen position. In more recent mobile communication terminals, the user can download a picture to be displayed on the display screen from a service provider and then store the downloaded picture in the mobile communication terminal.

FIG. 1 is a block diagram illustrating a function of editing a screen image in a conventional mobile communication terminal. Referring, to FIG. 1, if a user selects a screen-image editing mode in the conventional mobile communication terminal in step 10, it displays, for example, a picture deletion item 20 and a clock insertion item 30. The picture deletion item 20 is selected to remove a picture sub-image from a screen image displayed on a display screen. The clock insertion item 30 is selected to insert a clock sub-image into the screen image displayed on the display screen. When the user inserts the picture sub-image into the screen image displayed on-the display screen, the user can select one of pictures 1 to 5 (items 40, 42, 44, 46 and 48) and then display the picture sub-image on the display screen.

If the user selects the picture deletion item 20, the display screen displays a screen image 20a, including only a user's name sub-image and a clock sub-image without displaying the picture sub-image. When the clock insertion item 30 is selected, the display screen displays a screen image 30a, including the user's name sub-image and a large clock sub-image. Further, if the user selects one of pictures 1 to 5 (items 40, 42, 44, 46 and 48), the display screen displays the screen image 40a, including a corresponding picture sub-image, the user's name sub-image, and the clock sub-image.

However, because the screen image on a display screen provided in the conventional mobile communication terminal is uniformly configured, the conventional mobile communication terminal cannot always meet the user's desires based on the user's taste. In particular, the user of the conventional mobile communication terminal selects and combines the picture sub-image, the user's name sub-image and the clock sub-image, thereby creating one screen image. Because positions of pictures and characters are uniformly fixed, it is impossible for the user to change the positions of pictures and characters displayed on the display screen provided in the conventional mobile communication terminal. Further, although the user of the conventional mobile communication terminal replaces the pictures displayed on the display screen with other pictures, an overall display pattern cannot be changed. Accordingly, the conventional mobile communication terminal cannot be modified according to the user's preferences.

### SUMMARY OF THE INVENTION

Therefore, the present invention has been designed in view of the above problems, and it is an object of the present invention to provide an apparatus and method for editing a background screen image in a mobile communication terminal in which a user can directly design the screen image and newly configure a desired screen image based on the user's style.

In accordance with an aspect of the present invention, the above and other objects can be accomplished by an apparatus for editing a screen image in a mobile communication terminal including a display module, comprising: a controller for performing a control operation that enables at least one frame that forms the screen image to be configured on the display and displaying an editing menu corresponding to the at least one frame displayed on the display if a user selects the at least one frame to edit; and an interface module for receiving a user command corresponding to the at least one frame displayed on the display and providing the received user command to the controller.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a functions of editing a screen image in a conventional mobile communication terminal;

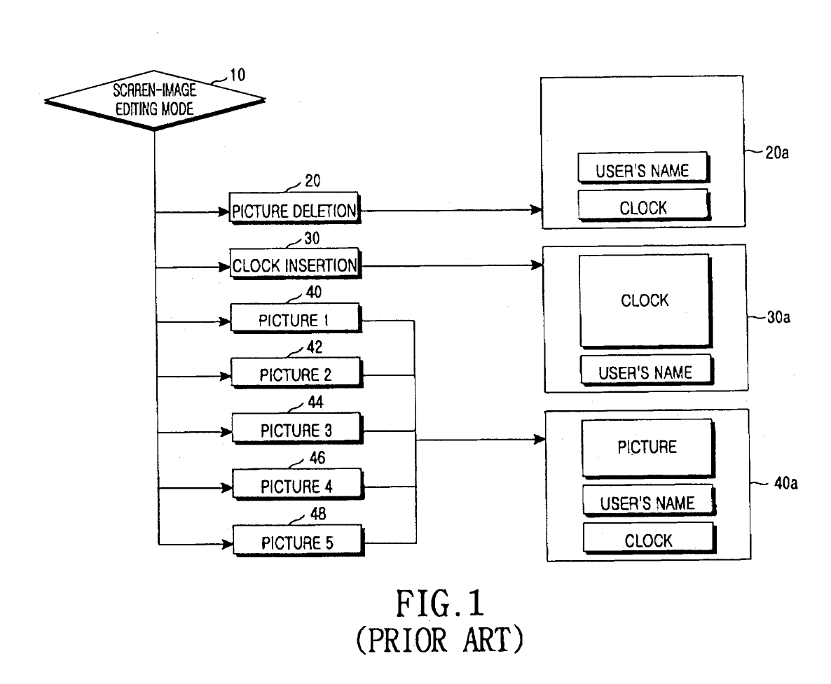

FIG. 2 is a block diagram illustrating a mobile communication terminal in accordance with the present invention;

FIG. 3 is a block diagram illustrating a function of editing a screen image in a mobile communication terminal in accordance with the present invention;

FIG. 4 is a detailed illustration of the function of editing a screen image as illustrated in FIG. 3;

FIG. 5 illustrates screen images displayed on a display module in accordance with the present invention;

FIG. 6 is a flow chart illustrating a method for displaying a screen image on a display module provided in a mobile communication terminal in accordance with the present invention;

FIG. 7 is an exemplary view explaining an editing process of a screen image in accordance with the present invention; and

FIG. 8 is another exemplary view explaining an editing process of a screen image in accordance with the present invention.

### DETAILED DESCRIPTION OF THE PREFERRED EMBODIMENTS

Preferred embodiments of the present invention will be described in detail herein below with reference to the annexed drawings. In the following description, detailed descriptions of known functions and configurations incorporated herein will be omitted when they may make the subject matter of the present invention rather unclear.

The present invention enables a user to directly design a screen image on a display module included in a mobile communication terminal. In accordance with the present invention, a picture sub-image, a user's name sub-image, and a clock sub-image can be implemented in one or more basic frames, respectively, enabling the user to readily edit the screen image displayed on the display module provided in the mobile communication terminal. The basic frames can be configured so that a size or position of the picture, clock, or user's name sub-image can be changed or adjusted on the display module. Through the basic frames, the user can newly configure the screen image displayed on the display screen. In accordance with the present invention, the screen image having the basic frames can be completely implemented within the mobile communication terminal. Alternatively, the user can configure the screen image having the basic frames on a personal computer and then download the configured screen image from the personal computer into the mobile communication terminal.

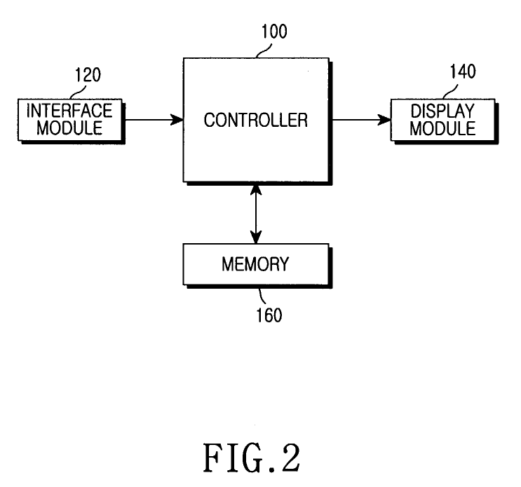

FIG. 2 is a block diagram illustrating a mobile communication terminal in accordance with the present invention. Referring to FIG. 2, the mobile communication terminal includes a controller 100, an interface module 120, a display module 140, and a memory 160. The controller 100 performs an overall control of the mobile communication terminal. Further, the controller 100 configures basic frames for a picture sub-image, a user's name sub-image, and a clock sub-image displayed on the screen image if a user of the mobile communication terminal selects a screen-image editing mode. Thereafter, the controller 100 controls the display module 140 so that it displays function keys capable of editing each basic frame by the user. In other words, the controller 100 provides the basic frames for respective elements configuring the screen image and a function of editing the basic frames, so that the user can readily edit the screen image.

In more detail, the controller 100 implements a basic-frame providing function, a picture-input-frame providing function, and a character-input-frame providing function. The basic-frame providing function provides the basic frames to enable the user to create a specific screen image. For example, the display module 140 provided in the mobile communication terminal displays the screen image. The screen image includes the picture sub-image, the user's name sub-image, the clock sub-image, etc. Positions of these sub-images can be separately changed. Accordingly, the basic-frame providing function enables the user to easily create the desired screen image based on the basic frames.

The picture-input-frame providing function is a function of selecting an actual picture and inputting the actual picture in a position designated by the user. For example, the user can download a picture from the Web. Further, the downloaded picture can be stored in the mobile communication terminal. The picture-input-frame providing function includes a rotation function, a picture size adjustment function, etc.

The character-input-frame providing function can provide a new character input frame as well as the basic frame for a character input. The character-input-frame providing function includes a character slide function, a character arrangement adjustment function, etc.

The display module 140 displays various messages under control of the controller 100. For example, the display module 140 can be implemented as an LCD (Liquid Crystal Display) or a TFT (Thin Film Transistor) LCD. The interface module 120 includes a plurality of numeric keys and function keys. The interface module 120 outputs input data corresponding to a key selected by the user to the controller 100. For example, the interface module 120 includes up, down, left, and right arrow keys to shift positions of pictures or characters of the basic frames in the screen image on the display module 140. The interface module 120 can be implemented as a key matrix or touch screen. Where the interface module 120 is implemented as a touch screen, the numeric, function, and arrow keys can be selected or input by an input tool such as a stylus pen.

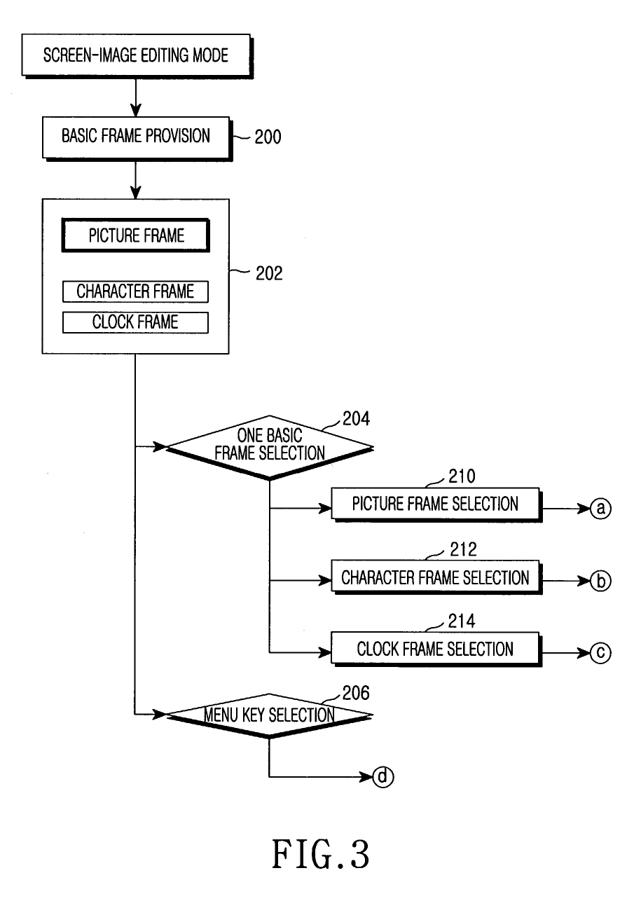

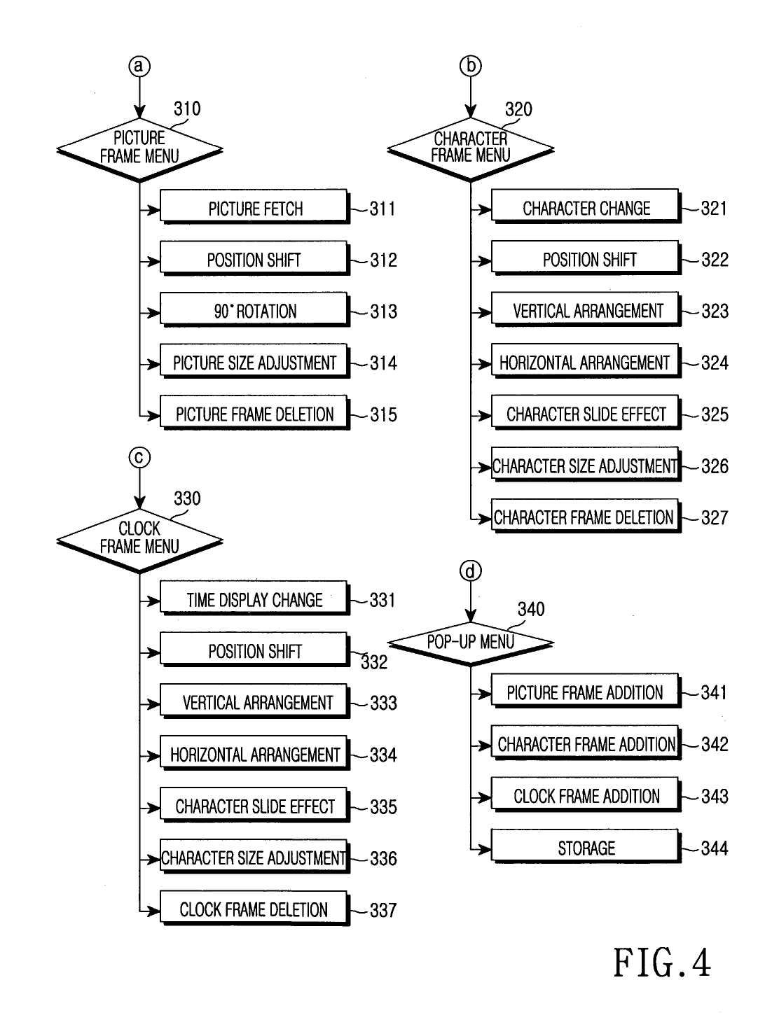

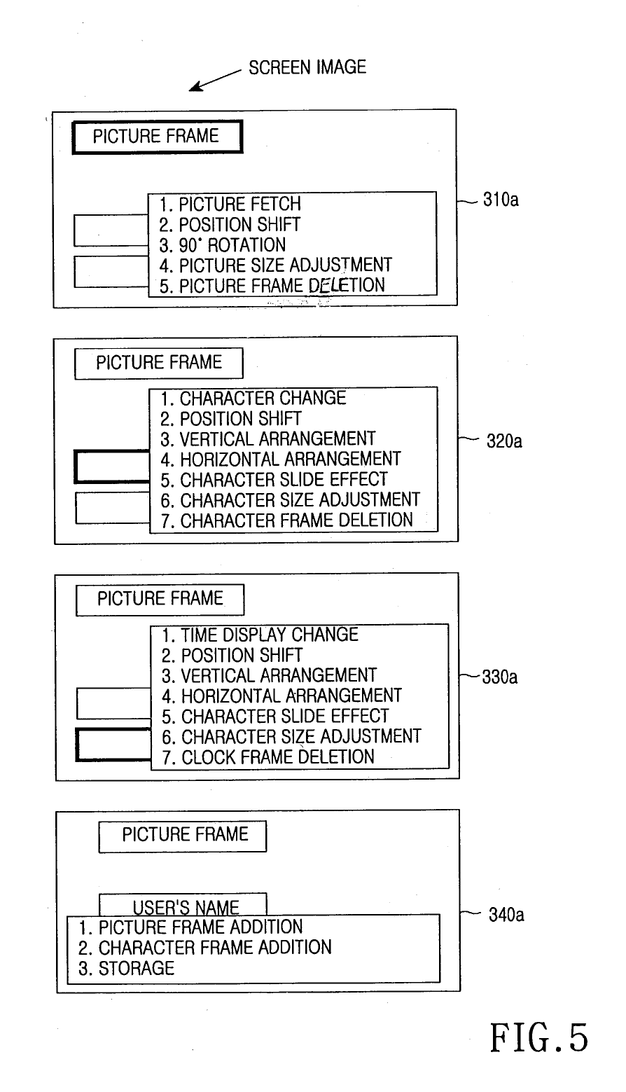

FIG. 3 is a block diagram illustrating a function of editing a screen image in the mobile communication terminal in accordance with the present invention. FIG. 4 is a detailed block diagram illustrating the function of editing a screen image as illustrated in FIG. 3. FIG. 5 illustrates screen images displayed on a display screen in accordance with the present invention.

Referring to FIGS. 3 to 5, if the user selects a screen-image editing mode in the mobile communication terminal in accordance with the present invention, the display module 140 provided in the mobile communication terminal displays a picture frame, a character frame having a user's name, and a clock frame, as basic frames on a screen image 202 to provide the screen image to the user in step 200.

Accordingly, the user can select one of the basic frames displayed on the screen image in step 204. If the user selects the picture frame of the basic frames in step 210, the display module 140 displays a pop-up menu as a picture frame menu on a screen image 310a illustrated in FIG. 5. The user can edit the picture frame using the picture frame menu contained in the screen image 310a displayed on the display module 140. In FIG. 4, the picture frame menu indicated by a reference numeral “310” includes a picture fetch item 311, a position shift item 312, a 90 degrees rotation item 313, a picture size adjustment item 314, and a picture frame deletion item 315. The user selects the picture fetch item 311 to select a stored picture and the picture is inserted into the picture frame of the screen image 310a displayed on the display module 140. The user selects the position shift item 312 to horizontally and vertically shift a position of the picture frame in the screen image 310a displayed on the display module 140. The user selects the 90 degrees rotation item 313 to rotate the picture frame in the screen image 310a displayed on the display module 140. The user selects the picture size adjustment item 314 to enlarge or reduce a size of the picture frame in the screen image 310a displayed on the display module 140. The user selects the picture frame deletion item 315 to delete the picture frame from the screen image 310a displayed on the display module 140.

Further, if the user selects the character frame of the basic frames in step 212, the display module 140 displays a pop-up menu as a character frame menu on a screen image 320a as illustrated in FIG. 5. The user can edit the character frame using the character frame menu contained in the screen image 320a displayed on the display module 140. In FIG. 4, the character frame menu indicated by a reference numeral “320” includes a character change item 321, a position shift item 322, a vertical arrangement item 323, a horizontal arrangement item 324, a character slide effect item 325, a character size adjustment item 326, and a character frame deletion item 327. The user selects the character change item 321 so that characters are changed or edited in the screen image 320a displayed on the display module 140. The user selects the position shift item 322 to horizontally and vertically shift a position of the character frame in the screen image 320a displayed on the display module 140. The user selects the vertical and horizontal arrangement items 323 and 324 to vertically and horizontally arrange the characters in the screen image 320a displayed on the display module 140. The user selects the character slide effect item 325 to activate a character slide effect in the screen image 320a displayed on the display module 140. The user selects the character size adjustment item 326 to change a size or font of a character in the screen image 320a displayed on the display module 140. The user selects the character frame deletion item 327 to delete the character frame from the screen image displayed on the display module 140.

On the other hand, if the user selects the clock frame of the basic frames in step 214, the display module 140 displays a pop-up menu as a clock frame menu on a screen image 330a as illustrated in FIG. 5. The user can edit the clock frame using the clock frame menu contained in the screen image 330a displayed by the display module 140. In FIG. 4, The clock frame menu indicated by a reference numeral “330” includes a time display change item 331, a position shift item 332, a vertical arrangement item 333, a horizontal arrangement item 334, a character slide effect item 335, a character size adjustment item 336, and a clock frame deletion item 337. Because the items 331 to 337 of the clock frame menu are similar to the items 321 to 327 of the character frame menu, a description of the items 331 to 337 is omitted here.

Further, if the user selects a menu key in step 206, the display module 140 displays a pop-up menu on a screen image 340a as illustrated in FIG. 5. The user can edit the basic frames or store the edited basic frames in the memory 160 using the pop-up menu contained in the screen image 340a displayed on the display module 140. In FIG. 4, the pop-up menu indicated by a reference numeral “340” includes a picture frame addition item 341, a character frame addition item 342, a clock frame addition item 343, and a storage item 344.

The user selects the picture frame addition item 341 to add the picture frame to the screen image 340a displayed on the display module 140. The user selects the character frame addition item 342 to add the character frame to the screen image 340a displayed on the display module 140. The user selects the clock frame addition item 343 to add the clock frame to the screen image 340a displayed on the display module 140. The user selects the storage item 344 to store an edited screen image.

If the basic frames have been completely edited, a combination of the edited basic frames is displayed so that the user can view the edited basic frames on the screen image displayed by the display module 140. Further, when the user has completely edited the basic frames, the combination of the edited basic frames is stored in the memory 160. Accordingly, the user can easily edit the basic frames on the screen image displayed by the display module 140.

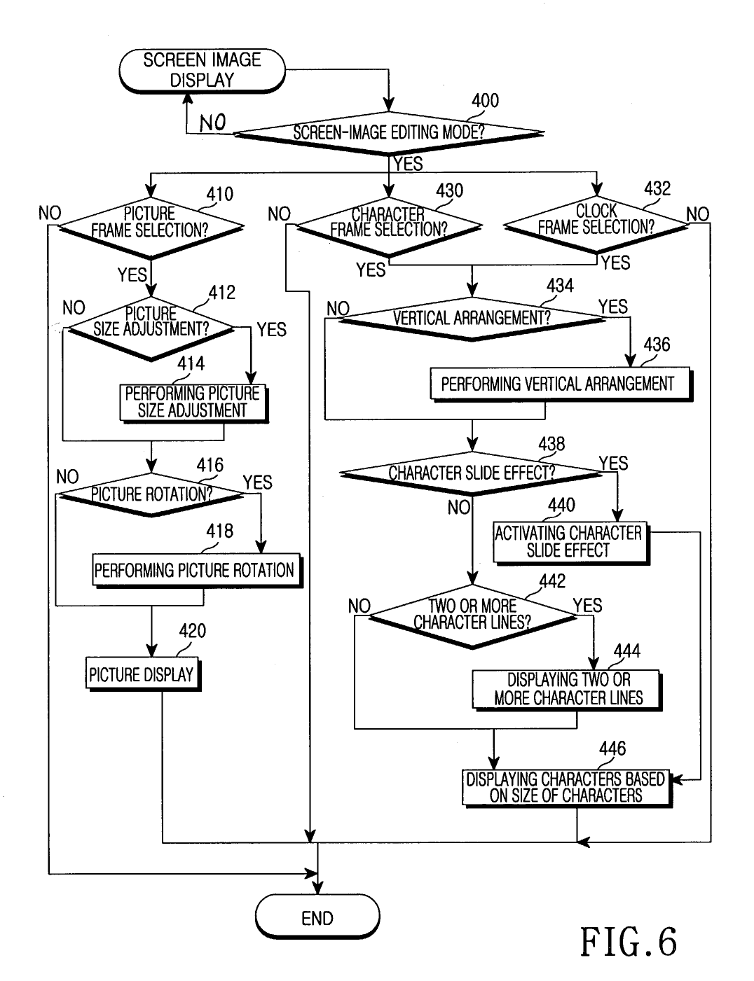

FIG. 6 is a flow chart illustrating a method for displaying a screen image on a display module provided in a mobile communication terminal in accordance with the present invention. Referring to FIGS. 2 and 6, an operation of the mobile communication terminal during a screen image editing mode is as follows.

The controller 100 of the mobile communication terminal determines in step 400 whether the user has selected a screen-image editing mode. If the user has selected the screen-image editing mode, the controller 100 determines whether the user has selected the screen-image editing mode, and then determines in step 410 whether the user has selected a picture frame in the screen-image editing mode. Further, the controller 100 determines in step 430 whether the user has selected a character frame in the screen-image editing mode. Furthermore, the controller 100 determines in step 432 whether the user has selected a clock frame in the screen-image editing mode.

If the user has selected a picture frame in the screen-image editing mode in step 410, the controller 100 determines a change of a size of a picture to be inserted into the picture frame in step 412. The controller 100 inserts a picture stored in the memory 160 into the picture frame contained in a screen image displayed on the display module 140. If a size of the picture is not appropriate to the picture frame of the screen image, the controller 100 adjusts the size of the picture to appropriately insert the picture into the picture frame in step 414. The controller 100 determines in step 416 whether the picture must be rotated in the screen image. If the picture must be rotated in the screen image, the controller 100 rotates the picture in step 418. The controller 100 commands the display module 140 to display the rotated picture in the screen image in step 420.

On the other hand, if the user has selected the character frame in step 430 or the clock frame in the screen-image editing mode in step 432, the controller 100 proceeds to step 434. The controller 100 determines in step 434 whether characters in the character frame or the clock frame must be vertically displayed. If characters in the character frame or the clock frame must be vertically displayed, the controller 100 commands the display module 140 to vertically display the characters in the character frame or the clock frame in step 436. That is, in response to the user's selection, the controller 100 commands the display module 140 to vertically display the characters in the character frame or the clock frame. Thereafter, the controller 100 determines in step 438 whether a character slide effect must be activated in the character frame or the clock frame. If a character slide effect must be activated in the character frame or the clock frame, the characters in the character frame or the clock frame are displayed on the basis of the character slide effect in step 440. Thereafter, the controller 100 determines in step 442 whether the number of character lines to be displayed in the screen image is larger than 2. If the number of character lines to be displayed in the screen image is larger than 2, the controller 100 commands the display module 140 to display two or more character lines at step 444. The controller 100 commands the display module 140 to display the character frame or the clock frame on the basis of a size of characters in step 446. As described above, the controller 100 commands the display module 140 to display the edited basic frames on the display module 140 in response to the user's selection.

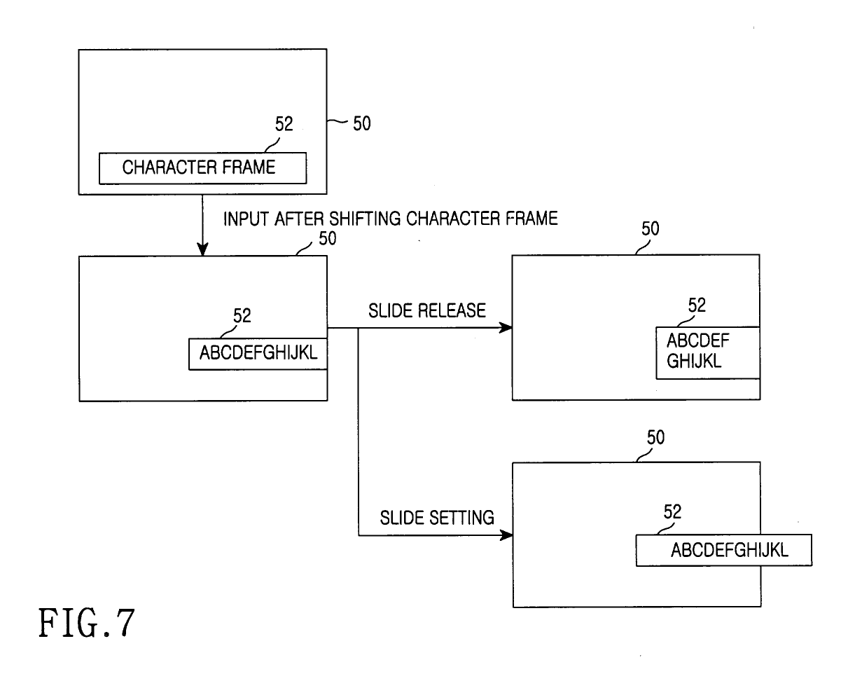

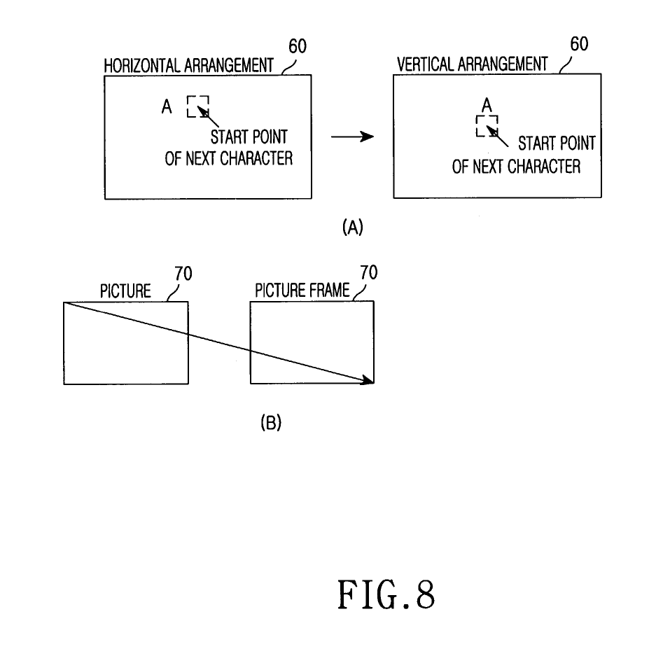

FIGS. 7 and 8 are exemplary views illustrating an editing process of a screen image in accordance with the present invention. Referring to FIG. 7, the user selects a character frame 52 in the screen-image editing mode so that the character frame 52 in a screen image 50 displayed on the display module 140 can be shifted to a predetermined position. At this time, the user can shift the basic frames using the interface module 120. Further, the user can input characters into the character frame. At this time, a size or font of the characters inputted into the character frame 52 can be edited. In response to the user's selection, the controller 100 commands the display module 140 to display characters having the character slide effect within the character frame 52. In response to the user's selection, the controller 100 can release the display of the characters having the character slide effect. When the characters having the character slide effect are displayed, one character line is displayed. When the display of the characters having the character slide effect is released, a plurality of character lines can be displayed.

Referring to FIG. 8(A), the display module 140 can vertically or horizontally display characters within the character frame or the clock frame in response to the user's selection. If the characters must be horizontally displayed, in a screen image 60, a line of next characters following a first character “A” are horizontally displayed. If the characters must be vertically displayed in a screen image 60, a line of next characters following a first character “A” are vertically displayed. FIG. 8(B) illustrates an example where a picture is rotated. The picture can be rotated by in 90 degree increments

As is apparent from the description above, the present invention provides an apparatus and method for editing a screen image in a mobile communication terminal in which a user can directly design the screen image and newly configure a desired screen image according to the user's preferences.

Although preferred embodiments of the present invention have been disclosed for illustrative purposes, those skilled in the art will appreciate that various modifications, additions, and substitutions are possible, without departing from the scope of the invention. Therefore, the present invention is not limited to the above-described embodiments, but the present invention is defined by the claims that follow, along with their full scope of equivalents.

What is claimed is:

1. An apparatus for editing a screen image in a mobile communication terminal including a display module, comprising:
a controller for performing a control operation that enables at least one frame that forms the screen image to be configured on the display and displaying an editing menu corresponding to the at least one frame displayed on the display if a user selects the at least one frame to edit; and
an interface module for receiving a user command corresponding to the at least one frame displayed on the display and providing the received user command to the controller.

2. The apparatus as set forth in claim 1, wherein the at least one frame includes any one of a picture frame, a character frame, and a clock frame.

3. The apparatus as set forth in claim 1, wherein a new frame is displayed with the at least one frame in response to a user command.

4. The apparatus as set forth in claim 1, wherein the at least one frames is deleted in response to a user command.

5. The apparatus as set forth in claim 1, wherein the editing menu corresponding to the at least one frame includes a pop-up menu.

6. The apparatus as set forth in claim 1, further comprising:
a memory for storing a combination of edited frames if the at least one frame is completely edited or combined with a new frame.

7. A method for editing a screen image in a mobile communication terminal including a display, comprising the steps of:
a) configuring at least one frame forming the screen image that is displayed on the display;
b) displaying an editing menu corresponding to a selected at least one frame on the display if a user selects the at least one frame to edit;
c) receiving a command selected in the editing menu corresponding to the selected at least one frame displayed on the display module; and
d) editing the at least one frame displayed on the screen image on the display according to the received command.

8. The method as set forth in claim 7, wherein the at least one frame includes any one of a picture frame, a character frame, and a clock frame.

9. The method as set forth in claim 7, wherein a new frame is displayed with the at least one frame in response to a user command.

10. The method as set forth in claim 7, wherein the at least one frame is deleted in response to a user command.

11. The method as set forth in claim 7, wherein the editing menu corresponding to the selected a t least one frame includes a pop-up menu.

12. The method as set forth in claim 7, further comprising:
e) storing a combination of the edited at least one frame in a memory if the edited at least one frame is completely edited or combined with a new frame.

13. A mobile communication terminal capable of editing a screen image in a display thereof, comprising:
a controller for performing a control operation that enables at least one frame that forms the screen image to be configured on the display and displaying an editing menu corresponding to the at least one frame displayed on the display if a user selects the at least one frame to edit; and
an interface module for receiving a user command corresponding to the at least one frame displayed on the display and providing the received user command to the controller.
